(19) United States
(12) Patent Application Publication
(10) Pub. No.: US 2026/0034582 A1
(43) Pub. Date: Feb. 5, 2026

(54) Refractory Metal Powder for Additive Manufacturing and Method for the Production Thereof

(71) Applicant: H. C. STARCK TUNGSTEN GMBH, Goslar (DE)

(72) Inventors: Tino SÄUBERLICH, Bad Harzburg (DE); Alexander ZEUGNER, Wolfenbuttel (DE); Alexander WOLFF, Hildesheim (DE); Alexander EGEBERG, Goslar (DE); Armin OLBRICH, Seesen (DE); Juliane MEESE-MARKTSCHEFFEL, Goslar (DE)

(21) Appl. No.: 18/995,309

(22) PCT Filed: Aug. 16, 2023
(86) PCT No.: PCT/EP2023/072530

§ 371 Date: Jan. 16, 2025

(30) Foreign Application Priority Data
Aug. 16, 2022 (EP) 22190596.1

(51) Int. Cl. B22F 1/06; B22F 1/052; B22F 9/04; B33Y 70/00

(52) U.S. Cl. CPC B22F 1/06; B22F 1/052; B22F 9/04; B22F 2009/043; B22F 2009/044; B33Y 70/00

(57) ABSTRACT

The present invention relates to a refractory metal powder for additive manufacturing, a method for its production, and to its use in additive manufacturing.

The present invention relates to a refractory metal powder for additive manufacturing, a process for the preparation thereof. and the use thereof in additive manufacturing.

### TECHNICAL BACKGROUND

The designation “additive manufacturing” summarizes all manufacturing processes in which, in contrast to subtractive processes, the workpiece is built up by adding volume elements or layers directly from digital 3D data in an automated way, or further volume elements are applied to an existing workpiece, thus producing three-dimensional objects. The layerwise construction is usually effected with computer control from one or more liquid or solid materials. The construction of the three-dimensional object is achieved by different physical and chemical curing and melting processes, so that the production of a concrete article of manufacture is possible without specific tools that have stored the respective geometry of the article of manufacture.

While the processing of plastics, synthetic resins and ceramics for producing complex models, specimens and prototypes finds a broad application in industry and research, the number of suitable metals is still limited. Among other things, this is due to the fact that the metals have to meet certain properties to be capable of being employed in additive manufacturing processes. The metal may be in a solid form, such as a rod or wire, or in powder form.

All manufacturing processes that start from a metal in powder form involve a number of requirements to be met by the metal to be processed. These include, among others, a high flowability and high bulk and tap densities, in order to achieve a uniform and defined application in the manufacturing process on the one hand, and to obtain a compact workpiece on the other.

Metal powders that meet the mentioned requirements profile usually have a high sphericity, which currently can be achieved only by energy-intensive melting and nozzle-jetting methods.

Thus, WO 2020/220143 describes a metal powder for additive manufacturing processes prepared by plasma treatment, which comprises spherical particles with a particle size distribution of from 0 to 1000 μm, and has a flowability of up to 20 s.

US 2022/0023941 discloses a metal powder for 3D impression, comprising a metal selected from the group consisting of tantalum, titanium, niobium, and alloys of tantalum, titanium, and niobium, wherein the particles of the metal powder have an average aspect ratio, ψ_{A}, of from 0.7 to 1, with ψ_{A}=x_{Feret min}/x_{Feret max}.

DE 10 2019 130 941 relates to a process for processing a metallic powder for additive manufacturing, comprising the following steps: a) at least two metallic powders with different physical properties are provided, in which at least one powder is a residual powder from additive manufacturing, and in which at least one other powder is new powder; b) said at least two powders are dosed and subsequently mixed into one powder mixture; c) said powder mixture is subsequently dried and thereafter separated into fractions, wherein in a first step a superfine fraction is separated by sifting, and from the residual fraction, a coarse grain fraction is separated from a remaining fraction by screening, or a coarse grain fraction and at least one fine grain fraction, are separated by screening in a screening device, wherein the remaining fraction is the processed metallic powder for additive manufacturing, wherein the processed powder was homogenized by the previous process steps and can be forwarded to further use.

In their article “Manipulation and characterization of novel titanium powder precursor für additive manufacturing applications”, issued in The Minerals, Metals & Materials Society, 2015, Vol. 67, No. 3, Y. Y. Sun et al. describe spherical Ti powders for additive manufacturing obtained from a precursor powder that is not suitable for use in additive manufacturing because of its large particle size and other morphology.

### Technical Problem

The melting of metals having very high melting temperatures, as typical of refractory metals, results in very high specific energy demands and thus in a high manufacturing cost. Although the prior art already holds some approaches for the lower melting refractory metals, such as titanium, niobium and tantalum, there is still a need for a satisfactory solution for the higher melting refractory metals, among which tungsten has the highest melting point and is additionally characterized by its unusual strength, which makes mechanical treatment more difficult, but at the same time makes it an attractive material.

In view of the above, it is the object of the present invention to provide a refractory metal powder, especially tungsten, that is suitable, on the one hand, for use in additive manufacturing. It is a further object of the present invention to provide a more sustainable process for producing such powders as compared to those known from the prior art.

### Technical Solution

Within the scope of the present invention, it has been surprisingly found that even powders that do not show the sphericity said to be indispensable in the prior art can be employed in additive manufacturing processes. Thus, it has surprisingly been found that even powders with particles deviating in shape from the usually sought ideal spherical shape are suitable for additive manufacturing.

### GENERAL REMARKS

Unless stated otherwise, the grain size distribution as determined by laser diffraction relates to the mass distribution of the particles. The following applies:

D10: 10% of the mass of the powder have a particle size that is smaller than the stated value, or 90% of the mass of the powder have a particle size that is larger than the stated value.

D50: 50% of the mass of the powder have a particle size that is smaller than the stated value, or 50% of the mass of the powder have a particle size that is larger than the stated value.

D90: 90% of the mass of the powder have a particle size that is smaller than the stated value, or 10% of the mass of the powder have a particle size that is larger than the stated value.

Within the scope of the present application, the terms “grain” and “particle” are used interchangeably, and so are the terms “grain size” and “particle size”.

In particular, “non-spherical particles” as used in the present invention means those that have a cylindrical or ellipsoid shape.

The term “fraction” as used in the present invention means the separated portion of a powder obtained by a separating process, wherein at least two fractions are formed in each separating process. Such separation may be effected by a characteristic feature, such as the mass, density, size, color or shape.

### DETAILED DESCRIPTION OF THE INVENTION

In a first aspect, the present invention relates to a non-spherical refractory metal powder selected from the group consisting of vanadium, chromium, molybdenum, and tungsten, and alloys thereof for the additive manufacturing of three-dimensional workpieces, wherein said powder consists of non-spherical particles, and wherein each particle has Aₙ dimensions, in which at least 2 of said dimensions Aₙ are different from one another. The dimensions of the particles can be determined, for example, by optical methods using scanning electron micrographs.

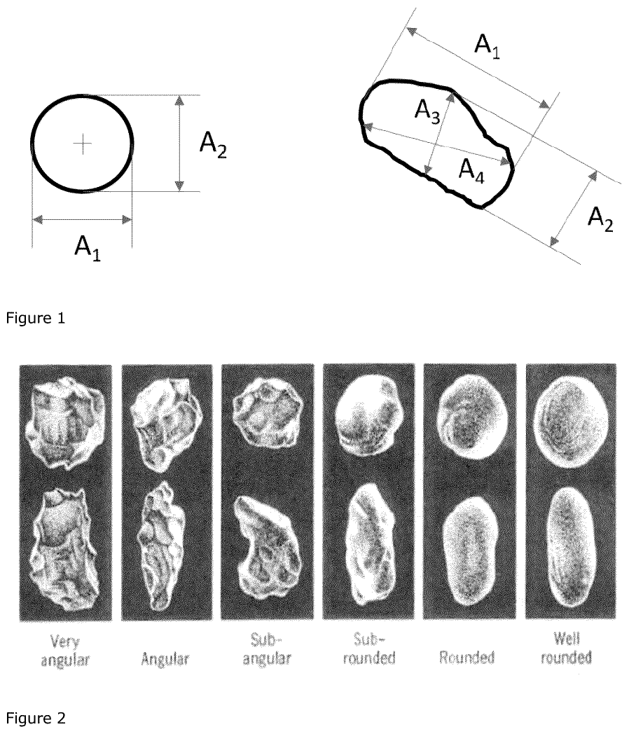

The term “dimension” as used in the present invention means any distance between two points on the surface of the particle whose connecting line runs through the particle's center of gravity. While spherical particles have the same distance from the surface to the center in all spatial dimensions, any number of dimensions can be determined in all particles of the refractory metal powder according to the present invention, of which respectively at least two, preferably at least 3, more preferably at least 4, are mutually different. While A₁=A₂ in a spherical particle, the powder according to the invention is characterized in that, in particular, it has at least two distances for which A₁≠A₂. For further illustration, reference is made to FIG. 1. In a particularly preferred embodiment of the refractory metal powder according to the invention, the minimum dimension Aₘᵢₙ and the maximum dimension Aₘₐₓ of a particle differ by a factor of f(A), in which f(A) has a value of from >1.001 to 5. In a further preferred embodiment, the particles have a ratio of the maximum dimension Aₘₐₓ to the minimum dimension Aₘᵢₙ (Aₘₐₓ/Aₘᵢₙ) of <5.

Within the scope of the present invention, it has been surprisingly found that powders consisting of non-spherical particles are characterized by a particular distribution function of their grain size, since the model of spheres having the same volume, on which the grain size distribution is usually based, does not apply here.

In a preferred embodiment, the refractory metal powder of the present invention is characterized by a grain size distribution that is determined as follows:
Screening the refractory metal powder using n screens, in which n≥2, and in which the screens have different mesh sizes;
obtaining F(xᵢ)=n+1 fractions, comprising a coarse grain fraction F(xᵢ+1) with F(xᵢ+1)>xᵢ; a medium grain fraction F(xᵢ) with F(xᵢ)=xᵢ, and a fine grain fraction F(xᵢ−1) with F(xᵢ−1)<xᵢ, wherein xᵢ represents the mesh size of the screen, and wherein xᵢ₊₁/xᵢ=aᵢ with 1.1≤aᵢ≤1.5;
determining the grain size distribution of the medium grain fraction F(xᵢ) obtained using laser diffraction,
   wherein the D90 value of the grain size distribution of the fraction F(xᵢ) as determined by laser diffraction is respectively larger than the mesh size of the screen xᵢ+1, in which xᵢ+1>xᵢ.

The screening may be effected in accordance with DIN 66165, wherein, for example, sieve towers with standardized test sieves as described in DIN ISO 3310 or ASTM B214 may be used.

The determination by laser diffraction can be effected in accordance with DIN ISO 13320.

In a preferred embodiment, aᵢ is essentially the same for all ratios xᵢ₊₁/xᵢ, wherein the deviation between the values is preferably less than 5%, more preferably less than 3%.

While for spherical particles it does not matter in which position a particle falls through the meshes of a screen, this is not the case with non-spherical particles. Here, there is a longitudinal dimension that is greater than the mesh size of the screen. Without being bound by theory, it is assumed that this effect causes the distribution of the fraction F(xᵢ) for non-spherical particles to contain a fraction that is coarser than the mesh size of the coarser screen xᵢ₊₁, wherein the grain size distribution of the fractions is respectively determined by laser diffraction.

The screening of the powder according to the invention within the scope of the determination of its grain size distribution is preferably effected using screens of a series in which the mesh sizes xᵢ of the screens respectively differ by a constant factor, especially using screens for which xᵢ₊₁=ai*xᵢ, wherein 1.38<aᵢ<1.43. Especially for powders that are designed for use in additive manufacturing, screens having a mesh size of up to 125 μm have proven particularly suitable. Therefore, an embodiment is preferred in which screens having the following mesh sizes xᵢ are used for the screening.

$${x}_{i} : 32 μm ( + / - 5 μm ) ;$$

$${x}_{i + 1} : 45 μm ( + / - 5 μm ) ; prefereably with {a}_{1} = 1.40$$

$${x}_{i + 2} : 63 μm ( + / - 8 μm ) ; prefereably with {a}_{2} = 1.40$$

$${x}_{i + 3} : 90 μm ( + / - 12 μm ) ; prefereably with {a}_{3} = 1.42$$

$${x}_{i + 4} : 125 μm ( + / - 20 μm ) ; prefereably with {a}_{4} = 1.38$$

The values in parentheses are tolerances describing the admissible deviations from the nominal mesh size.

The particle size distribution of spherical particles usually follows a Gaussian normal distribution. In contrast, it has surprisingly been found that the particle size distribution of the refractory metal powder according to the invention deviates from this distribution. Therefore, an embodiment is preferred in which the powder has a grain distribution that corresponds to a logarithmic normal distribution.

The present invention relates to refractory metals that have proven highly corrosion-resistant because of their passivation. The refractory metal powder according to the invention is selected from the group consisting of vanadium, chromium, molybdenum, and tungsten, and alloys thereof. More preferably, said refractory metal is tungsten and/or a tungsten alloy. Even more preferably, said refractory metal is tungsten, which preferably has been obtained by reduction from tungsten oxide.

The refractory metal powder according to the invention is adapted, in particular, to the requirements of additive manufacturing, wherein flowabilities of not more than 9 s have proven suitable, in particular, within the scope of powder printing methods. Within the scope of the present invention, it has been surprisingly found that this requirement is also met by the refractory metal powder according to the invention despite its non-spherical shape, which has previously been considered contra-indicative of a use in additive manufacturing. Therefore, an embodiment is preferred in which the refractory metal powder according to the present invention has a flowability of not more than 9 s, preferably not more than 6 s, as determined by means of ASTM B213.

Further properties that are critical to the suitability of a metal powder in additive manufacturing include the bulk density and the tap density. It has surprisingly been found that these properties are achieved by the refractory metal powder according to the invention, which, because of the non-spherical shape of its particles, which deviates from the actually favored spherical particle form could not be expected.

In a preferred embodiment, the refractory metal powder according to the invention has a bulk density of at least 40%, preferably more than 45%, more preferably more than 50%, of the theoretical density of the refractory metal, as determined according to ASTM B329.

Further preferably, the refractory metal powder according to the invention has a tap density of at least 45%, preferably more than 50%, more preferably more than 56%, of the theoretical density of the refractory metal, as determined according to ASTM B527. Thus, the powder according to the invention has both a bulk density and a tap density that is comparable with those of conventional powders having spherical particles.

The bulk and tap densities are stated as a ratio to the theoretical density of the refractory metal. For the exemplary case that said refractory metal is tungsten metal, a density of 19.25 g/cm³ is to be taken as a 100% reference. The theoretical densities of the refractory metals are known to those skilled in the art and can be taken from corresponding reference works.

The powder according to the invention differs from those of the prior art, in particular, by the non-spherical shape of its particles. The sphericity of a solid is defined as the ratio of the surface of a sphere having the same volume to the surface of the solid, wherein a sphericity of 1 describes a sphere. Therefore, an embodiment is preferred in which the refractory metal powder has a sphericity factor of <0.95, preferably from 0.65 to 0.9. The sphericity may be determined statically in accordance with ISO 13322-1 or dynamically in accordance with ISO 13322-2. Within the scope of the present invention, those refractory metal powders have proven particularly advantageous that have a particle shape of “sub-rounded” or “rounded”, according to Power's classification in: Power, M. C., Journal of Sedimentary Petrology, 1953, Volume 23, page 118 (cf. FIG. 2).

Refractory metal powders have a natural oxide passivation on the surface, which, although making them relatively corrosion-resistant, may lead to defects in the workpiece manufactured by additive manufacturing because of the incorporated foreign elements. Therefore, an embodiment is preferred in which the refractory metal powder has an oxygen content of at most 1000 ppm, preferably at most 500 ppm, as determined by means of LECO methods.

Refractory metal powders for additive manufacturing that are characterized by a high sphericity, as described in the prior art, have the disadvantage that they can be prepared only by plasma spheroidization or other energy-intensive atomization methods, in which the metal is molten or partially molten and sprayed, which involves a significant expenditure of energy, mainly with the high melting points of the refractory metals. In contrast, it has surprisingly been found that the powder according to the invention can be prepared by simple mechanical methods. These methods have the advantage, in particular, that the metal need not be heated above its melting point. Therefore, the present invention further relates to a process for producing the powder according to the invention, comprising the following steps:
i) providing a starting refractory metal powder selected from the group consisting of vanadium, chromium, molybdenum, and tungsten, and alloys thereof having a grain size distribution D10 of at least 10 μm and D90 of smaller than 1000 μm, as determined by laser diffraction;
ii) mechanically treating the starting refractory metal powder to obtain the refractory metal powder according to the invention.

The general profile of requirements for metal powders in additive manufacturing provide a minimum grain size of 10 μm. It has proven advantageous herein if the starting powder already has a corresponding grain size distribution, so that a first step of the process according to the invention is the provision of a starting refractory metal powder with a grain size distribution D10 of at least 10 μm, wherein D90 should be lower than 1000 μm.

Preferably, the particles of the starting refractory metal powder have a compact, non-porous structure in addition to the stated grain size distribution. Therefore, in a preferred embodiment, the starting refractory metal powder preferably has a density of at least 80% of the theoretical density, more preferably at least 90% and especially at least 95% of the theoretical density of the refractory metal. The theoretical densities of the materials are known to those skilled in the art and can be taken from corresponding table collections.

Within the scope of the process according to the invention, a starting refractory metal powder is subjected to a mechanical treatment. This mechanical treatment is surprisingly capable of providing the powder with the properties necessary for use in additive manufacturing, such as bulk density and tap density, with an expenditure of energy that is low as compared to that of melt spheroidization. Without being bound to theory, it is assumed that the mechanical treatment of the starting powder results in a smoothing of the surfaces of the particles, whereby the advantageous properties are achieved. Therefore, the mechanical treatment is preferably selected in such a way that there is no comminution of the particles.

In this connection, the mechanical treatment in a ball mill or jet mill have proven particularly advantageous.

Therefore, an embodiment of the process according to the invention is preferred in which the mechanical treatment of the starting refractory metal powder is performed in a ball mill. In order to limit the formation of platelets by compressing the particles, it has proven advantageous to select the size and number of grinding balls accordingly. Therefore, an embodiment is preferred in which the size of the grinding balls is at most 8 mm, preferably 4 mm or less, wherein the value designates the diameter of the grinding balls. Further, the mass of the grinding balls should be in an appropriate ratio to the mass of the powder to be treated. In this connection, an embodiment of the process according to the invention is preferred in which the weights of the starting refractory metal powder and the grinding balls are in a ratio of from 1:1 to 1:5. Both measures serve to limit the energy input and thus obtain powder particles in a shape suitable for additive manufacturing. The grinding balls may be made of iron-based materials, steel, Fe—Co, Ni alloys, ceramic or carbide. The mechanical treatment in the ball mill is preferably performed for a period of from 3 to 7 hours, preferably from 4 to 6 and especially from 4.5 to 5.5 hours. After this period, the powder particles had a suitable shape to be able to use the powder for additive manufacturing. In the mechanical treatment, the revolutions per minute of the ball mill is preferably selected to be lower than the critical revolutions per minute. The critical revolutions per minute of the ball mill depends on its diameter and is calculated according to:

$${n}_{c r i t i c a l} = \frac{0.705}{{d}_{m i l l} - {d}_{s p h e r e}} .$$

Alternatively, the mechanical treatment may also be performed in a jet mill. Therefore, an alternative embodiment of the process according to the invention is preferred in which the mechanical treatment of the starting refractory metal is performed in a jet mill.

According to the principle of a jet mill, particles are ground in a gas stream without using mechanical tools like, for example, high-speed rotors. The grinding gas is introduced into a grinding chamber through nozzles and accelerated so highly that the respective particles are carried away and hit one another. Since the treatment of the particles is mainly autogenous, this method is particularly suitable for the comminution of very hard materials. Surprisingly, it has been found that within the scope of the present invention, conventional jet mills can be employed to produce suitable particles for additive manufacturing.

According to the invention, the mechanical treatment is preferably performed under a grinding pressure of less than 8 bar. Preferably, a grinding gas having a grinding gas temperature of from 10 to 40° C. is used, in which the temperature relates to the gas under a grinding pressure. Surprisingly, it has been found that the grinding time can be shortened as compared to that of a ball mill by using a jet mill. Therefore, an embodiment is preferred in which the mechanical treatment is performed for a period of from 0.5 to 3 hours, preferably from 0.5 to 1.5 hours.

The mechanical treatment of the powder as provided according to the invention may already yield refractory metal powders having a number of properties required for use in additive manufacturing, especially with respect to the bulk and tap densities.

In a preferred embodiment, the refractory metal powder obtained may further be subjected to classification in order to obtain desired ranges of particle size, for example. Therefore, in a preferred embodiment, the process according to the present invention provides a step of fractionating the refractory metal powder.

The fractionation of the material to be ground is preferably performed by screening, especially through a sieve tower. Alternatively, the fractionation may also be effected by using other mechanical classification methods. For this purpose, apparatus such as gravity sifters, fluidized beds, zigzag sifters, cyclones, centrifugal separators, spiral sifters or dynamic wind sifters, or modifications of such basic principles, may be used.

If the mechanical treatment of the starting refractory metal is performed in a jet mill, it may be advantageously combined with fractionation by sifting. In this case, an embodiment is preferred in which the jet mill has a dynamic wind sifter. Preferably, classical sifter wheels are used whose revolutions per minute is set so high that the separation boundary that establishes itself is finer than the smallest grain size of the particles to be treated. Although in this case the grinding gas can leave the mill, the particles remain in the grinding space. Only the extremely fine fraction is removed from the mill together with the flow of grinding gas and can be separated off in a filter as a by-product.

A jet mill is usually operated in a continuous mode. Within the scope of the present invention, it has been found, however, that the jet mill operates advantageously in a batch mode in this case. The mill can be filled automatically, and the powder can be treated for the time stated above, and removed from the device in another step. Then, the plant can be filled again, and another treatment can be started. The discharge of the treated particles from the grinding space can be done by different variants. In a preferred embodiment, the ground material is blown through a flap or a valve, which opens after a predefined time, together with the flow of grinding gas from the grinding space into a separate filter. In an alternatively preferred embodiment, the treated refractory metal powder is separated off by decreasing the revolutions per minute of the sifter and a cyclone placed between the grinding device and the filter. After the discharging process, the revolutions per minute of the sifter can bee reset to the originally high value. Thereafter, the procedure may start anew and be repeated as many times until the desired amount has been completely processed.

The process according to the invention offers the advantage that the particle size distribution of the metal powders to be processed can be adjusted according to need and the intended processing method.

The refractory metal powder employed as the starting powder has a grain size distribution D10 of at least 10 μm. In a preferred embodiment, the starting refractory metal powder has a grain size distribution within the limits of 10 to 250 μm, preferably 10 to 150 μm, as determined by laser diffraction.

The refractory metal powder according to the invention is provided, in particular, for use as a material in additive manufacturing. Therefore, the present invention further relates to the use of a refractory metal powder according to the present invention in additive manufacturing.

The advantages of the present invention shall be further illustrated by means of the Figures and the following Examples, which should by no means be understood as limiting the idea of the invention.

### EXAMPLES/FIGURES

A tungsten metal powder having a starting particle size distribution D10 of 39.2 μm and D90 of 151 μm was processed as described in Examples 1 (ball mill) and 2 (jet mill).

The powder obtained was divided into individual fractions through the screens mentioned in Table 1.

TABLE 1

| | ideal screen series | quotient | |
|---|---|---|---|
| Fraction | with a = constant | aᵢ = xᵢ₊₁/xᵢ | selected screen |
| F₁ | 22.8175 | — | is not used |
| F₂ | 32.0798 | 1.4059 | 32 μm |
| F₃ | 45.1020 | 1.4059 | 45 μm |
| F₄ | 63.4104 | 1.4059 | 63 μm |
| F₅ | 89.1507 | 1.4059 | 90 μm |
| F₆ | 125.3399 | 1.4059 | 125 μm |

The obtained fractions

$${F}_{1} : < 45 μm > 32 μm$$

$${F}_{2} : < 63 μm > 45 μm$$

$${F}_{3} : < 90 μm > 63 μm$$

$${F}_{4} : < 125 μm > 90 μm$$

were measured for determining their D10, D50, D90 and D95 values of grain size distribution, each by using laser diffraction on a Mastersizer 3000 of the company Malvern Panalytical.

### 1. Ball Mill

In a ball mill (outer diameter=26 cm and length=45 cm) with 40 kg of 4 mm carbide balls, 20 kg of the tungsten metal powder was ground. The revolutions per minute of the mill was 40 rpm with a duration of 5 hours. Subsequently, the material was screened to <63 μm. The results are summarized in Table 2.

TABLE 2

| | D₁₀/μm | D₅₀/μm | D₉₀/μm | D₉₅/μm |
|---|---|---|---|---|
| Grain distribution of starting | 39.2 | 87.5 | 151.0 | 170.0 |
| material | | | | |
| Grain distribution after | 17.3 | 56.5 | 113.3 | 131.0 |
| rounding in the ball mill | | | | |
| Screening > 63 μm (mass | 69.0 | 94.8 | 131.5 | 143.0 |
| proportion 48%) | | | | |
| Screening < 63 μm (mass | 13.7 | 32.3 | 66.5 | 77.6 |
| proportion 52%) | | | | |

### 2. Jet Mill

In a second Example, the tungsten metal powder was processed in a jet mill. For this purpose, a jet mill of type AFG 100 from the company Alpine was used. The grinding pressure of the grinding gas (nitrogen (20° C.)) was set to 5 bar. The mill was equipped with 2 lateral nozzles with a bore of 1.9 mm and a bottom nozzle with a bore of 3 mm. The sifter wheel had a number of revolutions of 3000 rpm during the rounding and was set in such a way that only the extremely fine fraction formed (fine dust about 1 to 2%, based on the starting amount) could leave the grinding space. The rounding process took place with 7.5 kg of tungsten metal powder over a duration of 1 hour. The powder was subsequently fractionated by screening. The results are summarized in Table 3.

TABLE 3

| | D₁₀/μm | D₅₀/μm | D₉₀/μm | D₉₅/μm |
|---|---|---|---|---|
| Grain distribution of starting | 39.2 | 87.5 | 151.0 | 170.0 |
| material | | | | |
| Grain distribution after | 21.8 | 74.3 | 128.0 | 144.0 |
| rounding in the jet mill AFG | | | | |
| 100 | | | | |
| Screening < 106 μm > 63 μm | 72.0 | 91.4 | 116.0 | 124.0 |
| (mass proportion 38.5%) | | | | |
| Screening < 63 μm > 45 μm | 51.9 | 63.1 | 77.3 | 82.7 |
| (mass proportion 14.4%) | | | | |
| Screening < 45 μm > 32 μm | 35.6 | 45.6 | 58.4 | 63.2 |
| (mass proportion 14.0%) | | | | |
| Screening < 32 μm (mass | 13.6 | 22.3 | 35.7 | 39.8 |
| proportion 38.5%) | | | | |

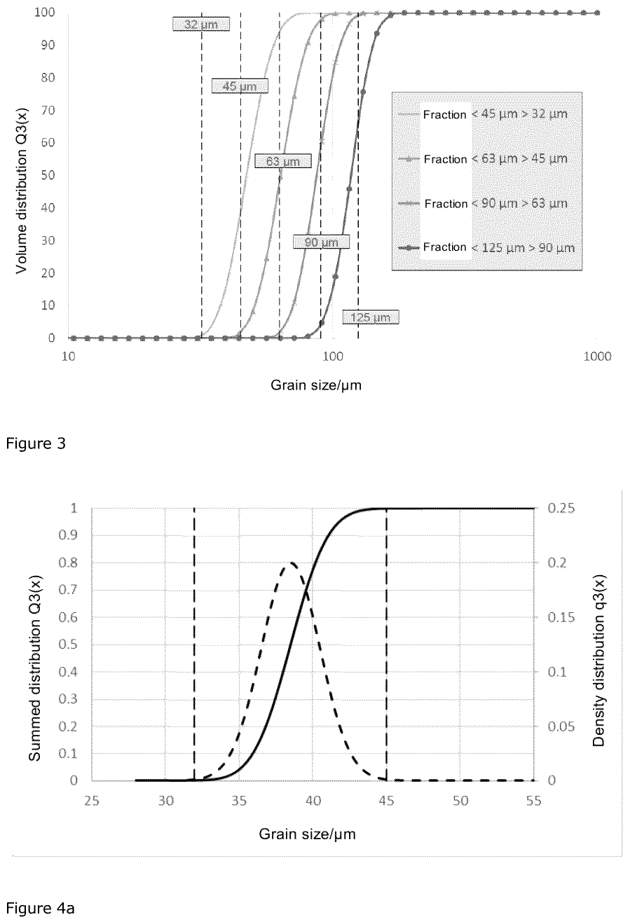

FIG. 3 shows the frequency distribution as measured by laser diffraction, wherein the dotted lines respectively indicate the mesh size of the screens employed. As can be seen, the grain size distribution of the fractions produced is significantly broader that would have been expected because of the screening. Thus, each grain size distribution established by laser diffraction significantly extends beyond the mesh size of the coarser screen. In the case of particles in the form of spheres having the same volume, each distribution should be exactly between the dotted lines. Therefore, the deviation is attributed to the non-spherical shape of the particles of the powder according to the invention. What can also be seen is the parallel shift of the distribution curves, which results from the series of selected screens (cf. factor a).

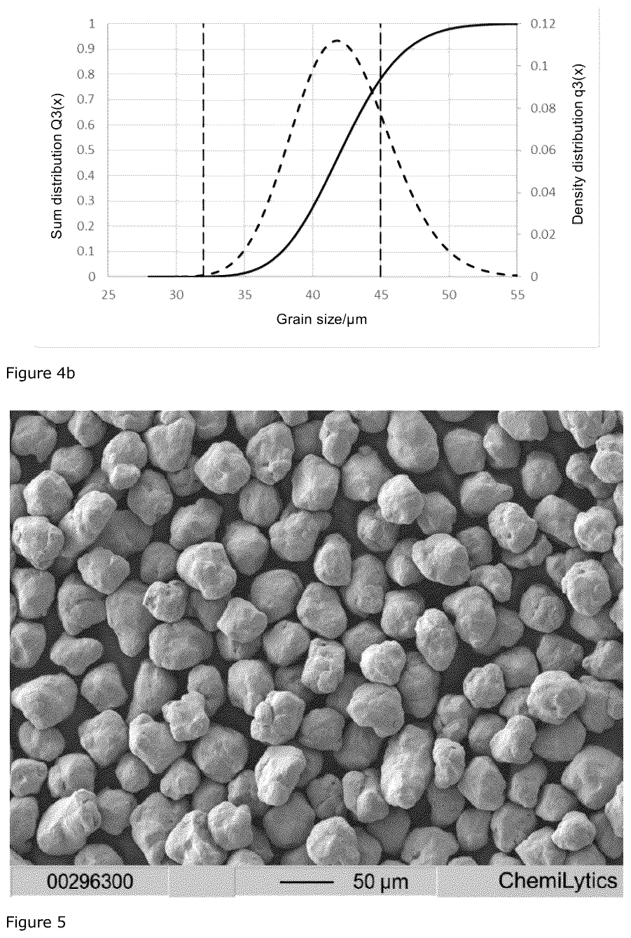

FIGS. 4a and 4b show the grain size distribution of a conventional tungsten metal powder with spherical particles in comparison with the grain size distribution of a tungsten metal powder according to the invention. FIG. 4a shows the grain size distribution of fractionated conventional spherical particles through: fine screen 32 μm; coarse screen 45 μm. FIG. 4b shows the grain distribution of fractionated non-spherical particles according to the present invention through: fine screen 32 μm; coarse screen 45 μm.

FIG. 5 shows a scanning electron micrograph of a tungsten metal powder according to the invention. The non-spherical shape of the particles is clearly seen.

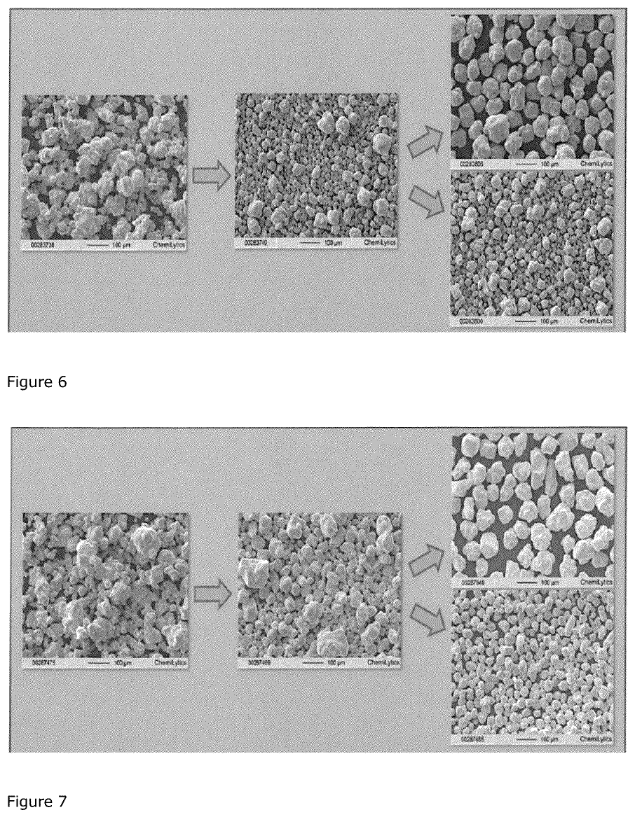

FIG. 6 shows a tungsten metal powder prepared according to Example 1 in a ball mill.

FIG. 7 shows a tungsten metal powder prepared according to Example 2 in a jet mill.

Within the scope of the discussion of sustainability, the issue of energy consumption plays a critical role. Table 4 gives a survey of the specific energy consumption of electric energy for the process according to the invention as compared to the melt spheroidization of tungsten metal powder.

TABLE 4

| | according to the | according to the | Comparison Melt |
|---|---|---|---|
| | invention | invention | spheroidization |
| | Ball mill | Jet mill | (RF plasma) |
| Energy input | <0.6 kWh/kg | 1-2 kWh/kg | >15 kWh/kg |

The specific energy consumptions represent an essential factor of the manufacturing cost and an ecologically sustainable production. The essential drawback of the conventional method of melt spheroidization is clearly seen in the very high energy expenditure. Especially in the processing of tungsten, a metal with a very high melting temperature, high amounts of energy are needed for the production of well flowable powders as required in additive manufacturing. In contrast, the process according to the invention indicates a simple and energy-efficient alternative.

1. A non-spherical refractory metal powder selected from the group consisting of vanadium, chromium, molybdenum, and tungsten, and alloys thereof for the additive manufacturing of three-dimensional workpieces, characterized in that said powder consists of non-spherical particles, wherein each particle has Aₙ dimensions, wherein at least 2 of said dimensions Aₙ are different from one another.

2. The non-spherical refractory metal powder according to claim 1, characterized in that said powder has a grain size distribution determined as follows:
screening the non-spherical refractory metal powder using i screens, in which i≥2, and in which the screens have different mesh sizes;
obtaining F(xᵢ)=i+1 fractions, comprising a coarse grain fraction F(xᵢ+1) with F(xᵢ+1)>xᵢ; a medium grain fraction F(xᵢ) with F(xᵢ)=xᵢ, and a fine grain fraction F(xᵢ−1) with F(xᵢ−1)<xᵢ, wherein xᵢ represents the mesh size of the screen, and wherein xᵢ₊₁/xᵢ=aᵢ with 1.1≤aᵢ≤1.5; and
determining the grain size distribution of the medium grain fraction F(xᵢ) obtained using laser diffraction,
wherein the D90 value of the grain size distribution of the fraction F(xᵢ) as determined by laser diffraction is respectively larger than the mesh size of the screen xᵢ+1, in which xᵢ+1>xᵢ.

3. The non-spherical refractory metal powder according to claim 2, characterized in that screens of a series in which the mesh sizes xᵢ of the screens respectively differ by a constant factor.

4. The non-spherical refractory metal powder according to claim 2, characterized in that screens having the following mesh sizes xᵢ are used for the fractionation:
$${x}_{i} : 32 μm + / - 5 μm ;$$
$${x}_{i + 1} : 45 μm + / - 8 μm ;$$
$${x}_{i + 2} : 63 μm + / - 12 μm ;$$
$${x}_{i + 3} : 90 μm + / - 20 μm ;$$
$${x}_{i + 4} : 125 μm + / - 20 μm .$$

5. The non-spherical refractory metal powder according to claim 1, characterized in that the powder has a grain size distribution that corresponds to a logarithmic normal distribution.

6. The non-spherical refractory metal powder according to claim 1, characterized in that the powder has a flowability of not more than 9 s, as determined by means of ASTM B213.

7. The non-spherical refractory metal powder according to claim 1, characterized in that powder has a bulk density of at least 40% of the theoretical density of the refractory metal, as determined according to ASTM B329.

8. The non-spherical refractory metal powder according to claim 1, characterized in that the powder has a tap density of at least 45% of the theoretical density of the refractory metal, as determined according to ASTM B527.

9. The non-spherical refractory metal powder according to claim 1, characterized in that the powder has a sphericity factor of <0.95, as determined by means of image analysis.

10. A process for preparing a refractory metal powder according to claim 1, comprising the following steps:
i) providing a starting refractory metal powder selected from the group consisting of vanadium, chromium, molybdenum, and tungsten, and alloys thereof having a grain size distribution D10 of at least 10 μm and D90 of smaller than 1000 μm, respectively determined by laser diffraction; and
ii) mechanically treating the starting refractory metal powder to obtain said refractory metal powder.

11. The process according to claim 10, characterized in that step ii) is performed in a ball mill, wherein the diameter of the grinding balls does not extend beyond at most 8 mm and/or the weight ratio of refractory metal powder to grinding ball is from 1:1 to 1:5.

12. The process according to claim 10, characterized in that step ii) is performed in a jet mill, wherein the pressure of the grinding gas does not exceed 8 bar.

13. The process according to claim 10, characterized in that the starting refractory metal powder has a grain size distribution of 10 to 250 μm, as determined by laser diffraction.

14. (canceled)

15. The non-spherical refractory metal powder according to claim 1, characterized in that the powder has a flowability of not more than 6 s, as determined by means of ASTM B213.

16. The non-spherical refractory metal powder according to claim 1, characterized in that powder has a bulk density of at least 45% of the theoretical density of the refractory metal, as determined according to ASTM B329.

17. The non-spherical refractory metal powder according to claim 1, characterized in that the powder has a tap density of at least 50% of the theoretical density of the refractory metal, as determined according to ASTM B527.

18. The non-spherical refractory metal powder according to claim 1, characterized in that the powder has a tap density of at least 56% of the theoretical density of the refractory metal, as determined according to ASTM B527.

19. The non-spherical refractory metal powder according to claim 1, characterized in that the powder has a sphericity factor of from 0.65 to 0.9, as determined by means of image analysis.

20. The process according to claim 10, wherein the diameter of the grinding balls does not extend beyond 4 mm.

21. The process according to claim 10, characterized in that the starting refractory metal powder has a grain size distribution of 10 to 150 μm, as determined by laser diffraction.
